(19) United States
(12) Patent Application Publication
(10) Pub. No.: US 2002/0169803 A1
(43) Pub. Date: Nov. 14, 2002

(54) System and user interface for generating structured documents

(76) Inventors: Sudarshan Sampath, Plainsboro, NJ (US); Peiya Liu, East Brunswick, NJ (US); Liang Hua Hsu, West Windsor, NJ (US)

Correspondence Address: Siemens Corporation, Intellectual Property Department, 186 Wood Avenue South, Iselin, NJ, 08830, US

(21) Appl. No.: 10/007,373

(22) Filed: Dec. 5, 2001

Related U.S. Application Data
(60) Provisional application No. 60/259,611, filed on Dec. 18, 2000.

(51) Int. Cl. G06F 15/00

(52) U.S. Cl. 707/513

(57) ABSTRACT

A document generator is provided, for generating structured documents on-the fly from product database. The method is based on high-level document generation specifications, which are SGML documents conformed to specification DTD. A document generator transforms document specifications and queries the product database to generate a structured SGML document. The document generator includes document generation specifications, a document structure template transformer, a document content filling operator, and a document maker.

This application claims the benefit of U.S. Provisional Application No. 60/259,611, filed Dec. 18, 2000.

### BACKGROUND OF THE INVENTION

1. Field of the Invention

The present invention relates to a system and method for generating structured documents, and more particularly to the generation of one or more structured documents from one or more data sources.

2. Discussion of Prior Art

The process of authoring a document has traditionally been achieved by manually composing documents using desktop authoring software, for example, MSWord and Interleaf. A manually authored document can have longer authoring times, be error prone, present layout problems, etc. For documents that have defined document structures, manual authoring can be tedious and repetitive.

Documents having a defined structure can be dealt with in a more efficient manner, for example, a reporting application may output data in a multi-column format. A table model maybe adequate to describe these documents, with formatting details left to the discretion of the author. This can be effective for collecting data in table forms.

A report produced with a reporting application (for

A report produced with a reporting application (for example, Oracle Reports) can be saved in, for example, PDF or HTML format. However, because the report lacks a logical structure, the report tends to be useful only for paper-based delivery of information or for online viewing as static web pages. The static table model may not be sufficient for structured documents. Furthermore, because of the loosely coupled contents of table models, the information contained therein can be difficult to navigate.

Document Type Definitions (DTDs) specify syntax, or element types, of a web page in the Standard Generalized Markup Language (SGML). Element types represent structures or desired behavior. Methods of using syntax for manipulating documents have been proposed, for example, using template base approaches to capture content. However, these methods fail to capture content in a structured format.

Therefore, a need exists for a system and method for automatically generating one or more structured documents from one or more media sources.

### SUMMARY OF THE INVENTION

According to an embodiment of the present invention, a document generation system is provided, for producing a structured document from information derived from an information repository. The system includes a source of document generation control information determining a desired presentation format and content structure of a generated document. The system further includes a document template generator for applying the control information in generating a template document structure comprising item locations designated for ordered data items. The system includes a document processor for applying the control information in filling template document item locations with corresponding ordered data elements derived from the information repository to produce a generated document.

The document processor further applies the control information in transforming the generated document to be compatible with the desired presentation format to produce an output document. The document processor further transforms the output document for incorporation in an electronic browseable directory.

The document processor applies the control information in filling template document item locations by identifying information elements in the information repository associated with individual item locations using attributes in the control information associated with individual locations, and by retrieving information elements identified by the attributes from the information repository for insertion in corresponding item locations.

The document processor examines the template document item locations and marks them for content filling with a content identification marker, and retrieves information elements identified by the marker from the information repository for insertion in corresponding item locations. The document processor also marks an item location in the template document with a content style attribute, and retrieves a corresponding content style attribute identified by the marker from the information repository and uses the attribute in processing an information element for insertion in the item location.

The template document comprises a row and column tabular structure of item locations and the document processor searches the information repository for corresponding data elements in one or more of, (a) row order and (b) column order.

The generated document includes one or more of, (a) an SGML document, (b) an XML document, (c) an HTML document (d) a document encoded in a language incorporating distinct content attributes and presentation attributes, and (e) a multimedia file.

The source of document generation control information comprises an SGML document comprising an expandable document structure.

The document template generator applies the control information to generate the template document structure by expanding item location nodes in a data structure derived from the control information, the item location nodes being designated to hold ordered data items.

The document template generator expands the data structure derived from the control information in response to an instruction in the control information.

The control information includes an expandable document structure identified by a language type definition descriptor. The document template generator generates a template document structure by expanding the expandable document structure in a manner compatible with the document structure language identified by the descriptor.

According to an embodiment of the present invention, a document generation system is provided, for producing a structured document from information derived from a database. The system includes a source of document generation control information comprising an expandable document structure, the control information determining a desired presentation format and content structure of a generated document. The system further includes a document template generator for expanding the expandable document structure to provide a template document structure comprising item locations designated for hierarchically ordered data items. The system includes a document processor for applying the control information in filling template document item locations with corresponding hierarchically ordered data elements derived from the database, to produce a generated document.

The document processor examines the template document item locations and marks them for content filling with a content identification marker, and retrieves information elements identified by the marker from the information repository for insertion in corresponding item locations. The document processor also marks an item location in the template document with a content style attribute, and retrieves a corresponding content style attribute identified by the marker from the information repository and uses the attribute in processing an information element for insertion in the item location.

According to an embodiment of the present invention, a graphical User interface system is provided, supporting processing of a document specification file to provide information supporting generating a structured document. The system includes a menu generator for generating: at least one menu permitting User selection of the document specification file and a document format, and an icon for generating the structured document from the document specification corresponding to a database. The structured document comprises content placeholders and attribute placeholders.

The system further includes a second menu for generating the structured document. The second menu for generating the structured document includes a document structured template transformer, a document content filler, and a document maker.

According to another embodiment of the present invention, a method is provided for generating a structured document from information derived from a database. The method includes receiving generation control information comprising an expandable document structure, the control information determining a desired presentation format and content structure of a generated document. The method further includes expanding the expandable document structure to provide a template document structure containing item locations designated for ordered data items. The method includes applying the control information in filling template document item locations with corresponding ordered data elements derived from the database, to produce a generated document by retrieving information elements from the database determined by content identification attributes in the control information for insertion in filling template document item locations.

The method applies a content style attribute in the control information in processing an information element for insertion in the template document item locations. The content style attribute comprises at least one of, (a) number of characters per line, (b) number of lines per page, (c) font type and size, and (d) text style.

### BRIEF DESCRIPTION OF THE DRAWINGS

Preferred embodiments of the present invention will be described below in more detail, with reference to the accompanying drawings:

FIG. 1a is a flow chart of a specification-based SGML structured document generation method according to an embodiment of the present invention;

FIG. 1b is a diagram showing a system for structured document generation according to an embodiment of the present invention;

FIG. 2a is a flow chart of document node expanding and document template transformation according to an embodiment of the present invention;

FIG. 2b is a flow chart of a search sequence according to an embodiment of the present invention;

FIG. 3 is a flow chart of a document content filling operation according to an embodiment of the present invention;

FIG. 4 is an illustrative example of a user interface according to an embodiment of the present invention; and

FIG. 5 is a view of a Dynatext® Browser including a structured document according to an embodiment of the present invention.

### DETAILED DESCRIPTION OF PREFERRING EMBODIMENTS

The present invention provides a document generator, which implements document generation specifications for automatically creating structured documents from a database. The document specifications can be high-level SGML documents wherein the structured documents are SGML-based. The document generator includes a document structure template transformer, a document content filling operator and a document maker.

The document structure template transformer takes document specifications as input, and restructures, translates and instantiates the specifications into structured document templates including placeholders for content and attributes. The document content filling operator takes the document template as input and queries the database to fill the content placeholders and attribute placeholders inside templates. The document maker takes the generated documents and publishes them as a browseable book or file. The document generator works as a specification transformer from high-level specifications into SGML structured documents.

SGML document structure can be represented by an abstract data model. In the abstract data model, the model is centered around the data.

The document generator can be designed for generating structured documents on-the-fly from the database, for example, a product database. The document generation specification is a formal description of the document types, structures and contents. The formal descriptions can be based on an ISO document standard, SGML, and a Document Type Definition (DTD) Specification. One of ordinary skill in the art will appreciate that other specifications can be used.

Documents have a logical structure, which can be described as a tree including zero or one document type declaration node or doctype node, a root element node, and zero or more comments or processing instructions. The root element serves as the root of the element tree for the document.

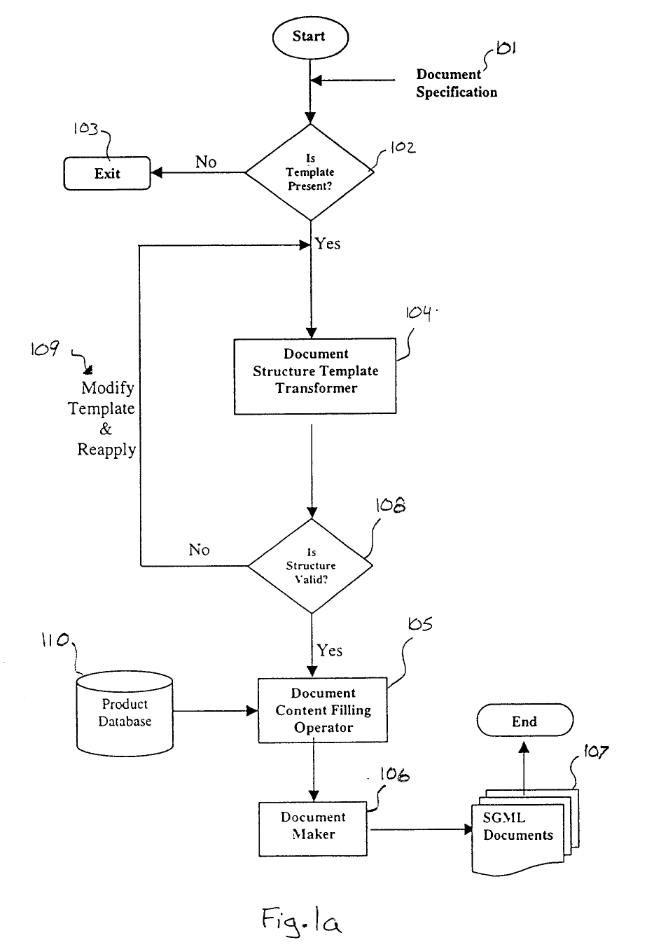

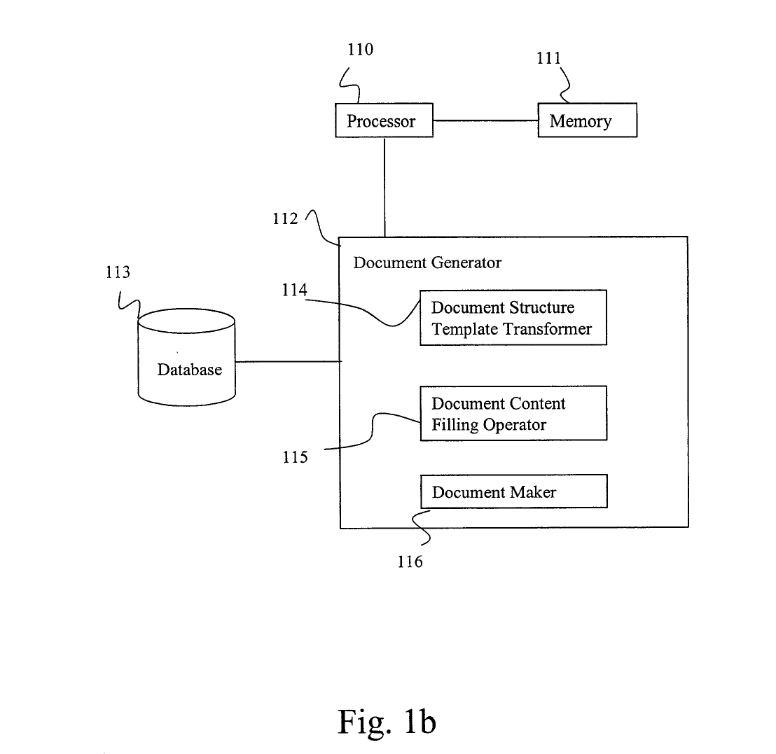

Referring to FIG. 1a, the document generator queries a database for a document specification 101 and determines whether a template is available 102. Upon determining that the template is not available, the document generator exits 103. Upon determining that the template is present, the Document generator implements a document structure template transformer 104, a document content filling operator 105 and a document maker 106 to generate a set of SGML documents 107. The set of SGML documents 107 can be published as electronic book by the document maker 106.

The document structure template transformer 104 performs document node expanding and document template transformation. The document structure template transformer 104 translates document generation specifications 101 into intermediate structure templates by expanding nodes in the document specifications and transforming the structure of document specifications 101. The document specification transformation is validated 108 to conform with the document type definition (DTD). If the document structure is not valid, the template is modified and reapplied 109. The document structure can be validated using any commercial validating program, for example, the World Wide Web Consortium's validator service.

Referring to FIG. 1b, showing a system for generating a structured document, the system includes a processor 110, a memory 111, and a document generator module 112. The document generator module 112 is connected to the database 113. The document generator module 112 comprises a document structure template transformer module 114, a document content filling operator module 115 and a document maker module 116 to generate at least one SGML document.

An exemplary structure comprising document generation specifications with dynamically queriable <DocSpec> types is shown below.

< ! DOCTYPE DOCSPECLIST SYSTEM “partsdoc.dtd”>
<DocSpecList>

<Global Params>
... (all global parameters)
</GlobalParams>
<Database>
... (database connectivity parameters)
<DocSpec>
... (for one type of document, structure and

placeholders)

</DocSpec>
<DocSpec>
... (for another type of document, structure and

placeholders)

</DocSpec>
<DocSpec>
... (nth-type document)
</DocSpec>

</DocSpecList>

An instance of the <DocSpec> shown above is given in Appendix 1.

Within the document structure, content and attribute sections can include placeholders. Elements can have associated properties, called attributes or variables, which can have values. Variable-value pairs appear before the final “>” of an element's start tag. Any number of attribute value pairs, separated by spaces, may appear in an element's start tag. For example, in the document structure shown below, $ColIndex$ represents an attribute placeholder and $UI_Col_Header$ represents a content placeholder.

placeholder.

<PartsList>

<Table>
<Title></Title>
<TGROUP COLS=“$NunOfColumnsInReport$”>

<COLSPEC COLNANE=“$ColIndex$”
COLWIDTH=“$UI_Col_Width$”
Expand=“$NumOfColumnsInReport$”>

<THEAD VALIGN=“TOP”>

<ROW>

<ENTRY COLNANE=“$ColIndex$” MOREROWS=“0”

ROTATE=“0” ROWSEP=“0”
Expand=“$NumOfColumnsInReport$”>

<PARA Expand = “$MaxDBFieldsPerColumn$”>

$UI_Col_Header$</PARA>

</ENTRY>

</ROW>

</THEAD>

<TBODY>

<ROW Loop=“RecordCout” Query=“Q_PartsList”>

<ENTRY COLNAME=“$ColIndex$” MOREROWS=“0”

Rotate=“0” Expand=“$NumOfColumnsInReport$”>

<PARA Expand =

“$MaxDBFieldsPerColumn$”>
$UI_Col_Header$</PARA>

</ENTRY>

</ROW>

</TBODY>

</TGROUP>

</Table>

<PartsList>

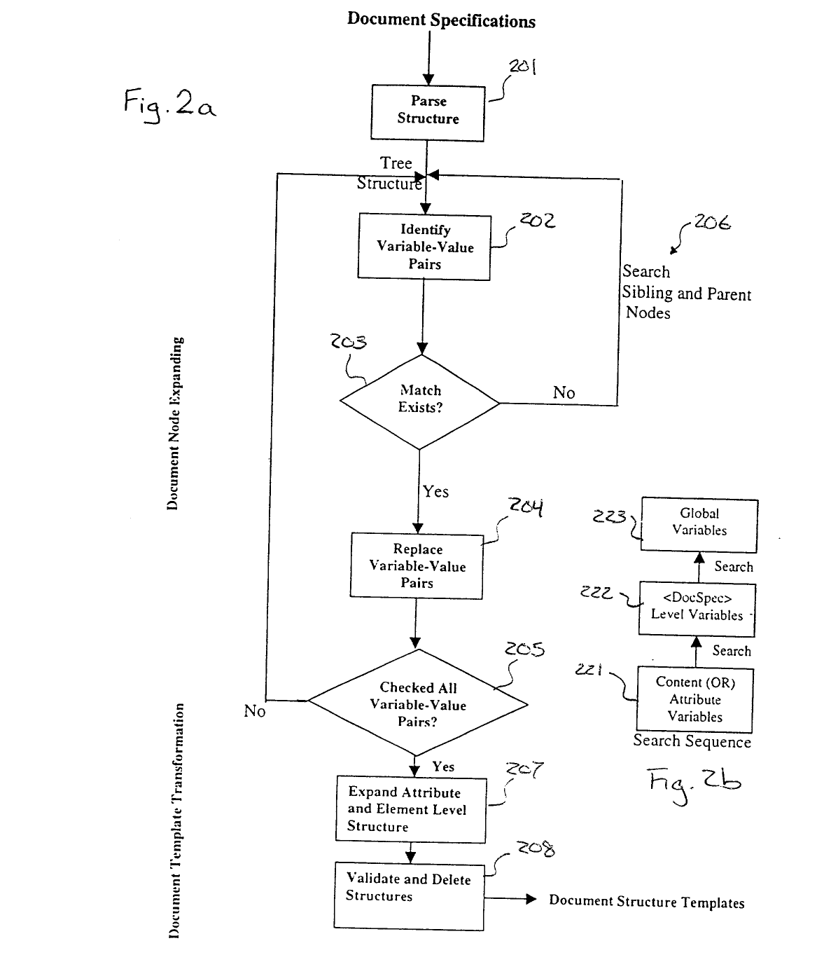

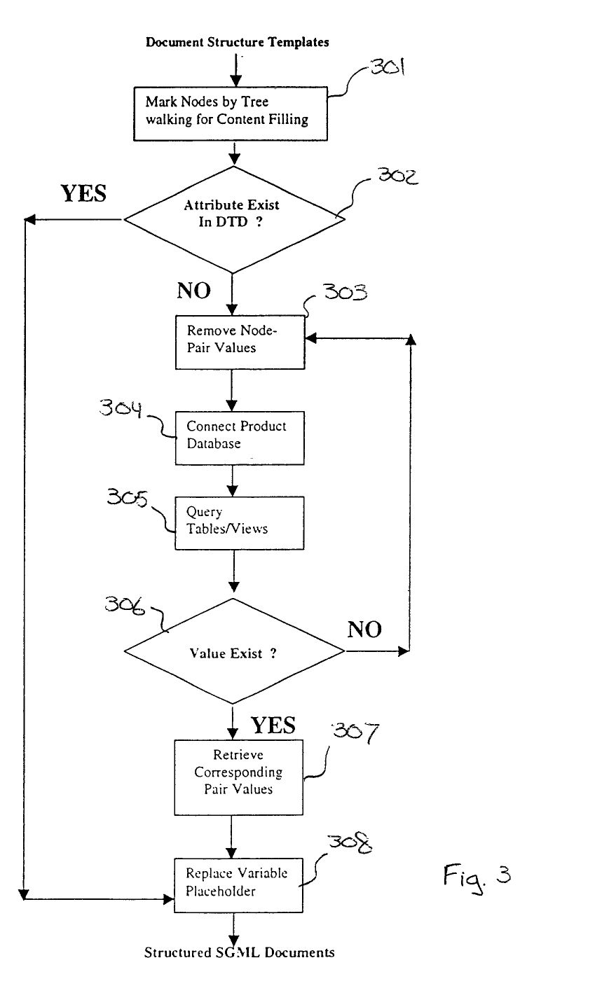

FIG. 2a illustrates a method of document node expanding and document template transformation. The method performs a search sequence (shown in FIG. 2a), parsing the structure of the document 201, identifying variable-value pairs 202, determining whether a match exists between a given variable and a value 203, replacing variable-value pairs 204, and determining whether the set of the variable-value pairs have been checked 205. Upon determining that a mismatch exists between a variable-value pair, the method searches sibling and parent nodes for a match 206.

The document structure template transformation checks attributes for further structure expanding in templates. If there are directives provided for the processor to expand the structure, then the method iterates through the structure 207 and creates an exact replica of nodes based on the skeletal structure 208.

For example,

<COLSPEC COL=“$ColIndex$” COLWIDTH=“$UI_Col_Width$”

Expand=“$NumOfColumnsInReport$”>

If “$NumOfColumnsInReport$” = 3 then,
“$ColIndex$” is set to 3
Structure becomes
<Colspec Col=“1” COLWIDTH=“$UI_Col_Width$” Expand=“3”>
<Colspec Col=“2” COLWIDTH=“$UI_Col_Width$” Expand=“3”>
<Colspec Col=“3” COLWIDTH=“$UI_Col_Width$” Expand=“3”>
“$UI_Col_Width$” values for each of the <Colspec>

values come from GUI (input by the user)

The Variable Names can be replaced with Values. The values determined from, for example, defaults designated in the <DefineVar>; directives issued to read registry/environment variables; and comes from the database. For example, the “$MachineSpec$” variable(see Appendix 1) in the attribute value nodes and queries is replace with the value “800336” coming from the <GlobalVar> section. As shown in FIG. 2b, replacement follows a search sequence that traverses the tree structure up a hierarchy tree. The hierarchy tree can include, for example, at a low level the content 221, a <DocSpec> level variable 222, and at a high level, the global variables 223.

The document content filling operator 105 (FIG. 1a) examines the intermediate document structure template using a document tree walking procedure to determine all placeholders, including document element attributes, and content, and retrieve the document content and attributes from product database 110 to fill the placeholders for content and attributes.

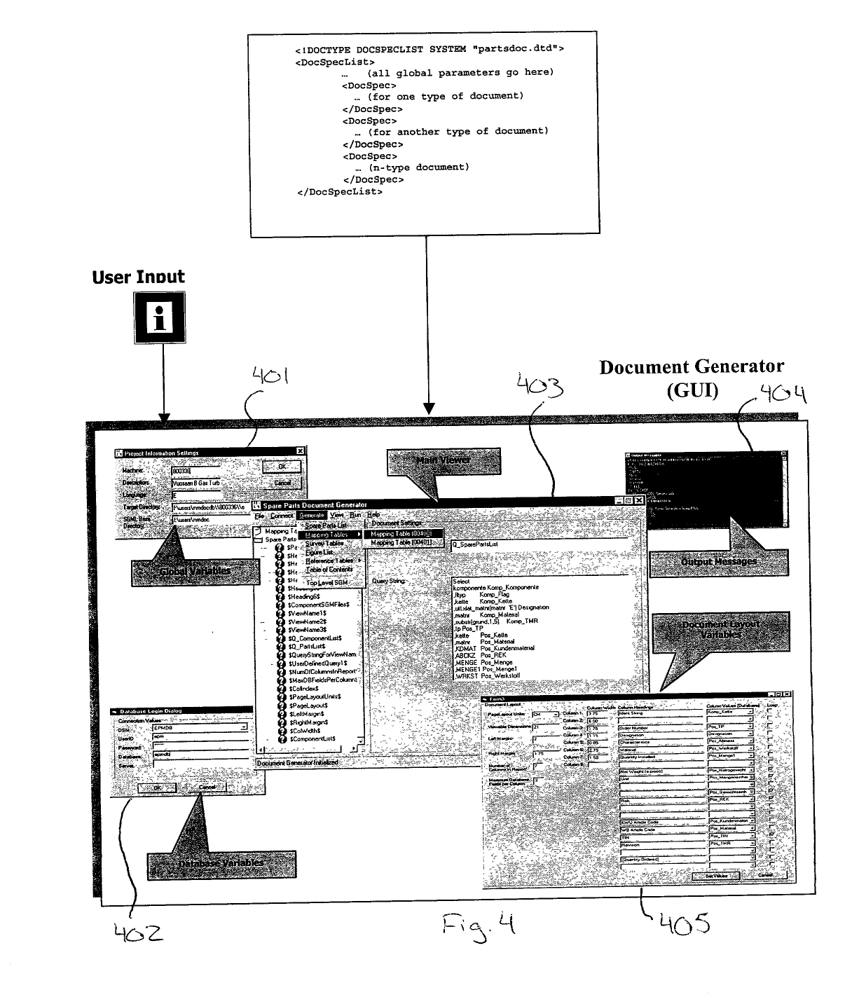

Referring to FIG. 3, the document tree walking process marks the Variable Nodes for Content Filling 301. The variables can be replaced with values in the form of a database field, if a variable is not replaced, then it can be marked for deletion 208 (FIG. 2a). The method validates the replacement against the DTD 302 (FIG. 3) to ensure the correctness of the structure. For example, given an expanded structure, such as the example given above, generated during a document template transformation, a variable “$UI_Col_Content$” can be replaced with a value such as a database column name, e.g., “$PartNumber$”. The value “$PartNumber$” happens to be a field name in the database table that is being queried. Node pair values can be removed 202 (FIG. 2a). Within the database 304, the document content filling operator 115 (see FIG. 1b) looks for these database column names in the structure, and queries the table for values 305 one row at a time 306 so long as no value exists. Upon determining a value, the method retrieves a corresponding pair of values 307. A variable placeholder can then be replaced 308.

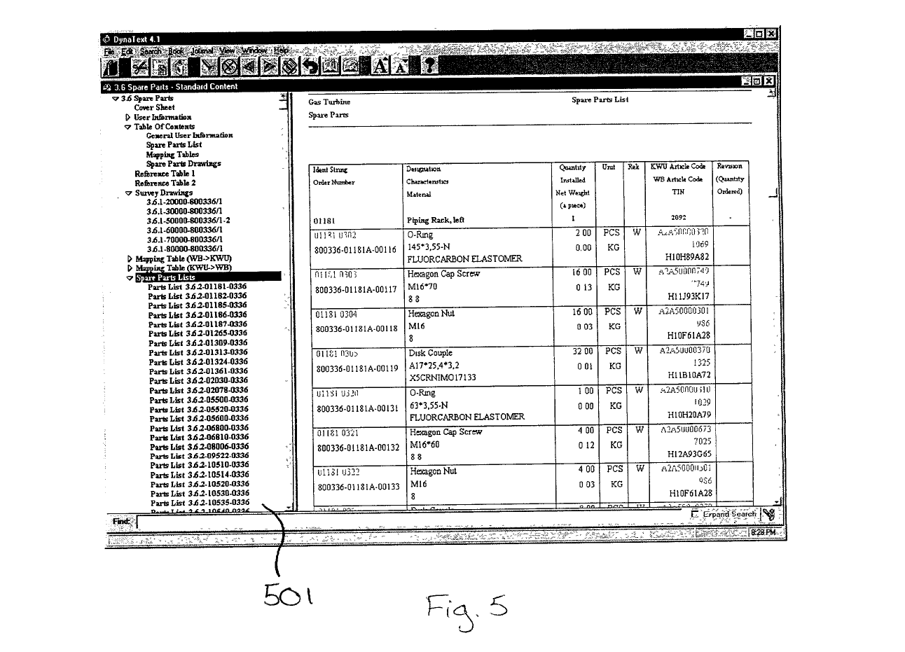

According to an embodiment of the present invention, a user interface can be provided, including a plurality of dialog boxes or windows. FIG. 4 is an illustrative example including, inter alia, a global variable dialog box 401 for accepting a machine number, a description of the document, a language, target directories including a SGML base directory, etc. Other types of input and output interfaces can include, a database variable dialog box 402, a main viewer 403, an output message window 404, and a document layout variable dialog box 405 for modifying, inter alia, margins widths and column headings.

Once a document has been rendered, for example an SGML document, the document can be presented in any suitable browser. For example, a Dynatext® Browser as shown in FIG. 5, wherein a document tree 501 is included for browsing the document.

Having described embodiments for a system and method of generating a structured document, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

Appendix 1.

<DocSpec>

<DefineVar Name=“$PartsList$”>

<! [ CDATA [Gas Turbine Spare Parts] ]>

</DefineVar>
<DefineVar Name=“$Heading1$”>

<! [ CDATA [Gas Turbine] ]>

</DefineVar>
<DefineVar Name=“$Q_ComponentList$”] ]>

<! [ CDATA [Select distinct komponents, aufnr

from $ViewName1$ where aufnr = ′$MachineSpec$′] ]>
</DefineVar>
<DefineVar Name=“$QueryStringForViewName3$”>

<! [ CDATA [select * from $ViewName#$] ]>

</DefineVar>
<DefineVar Name=“$UserDefinedQuery1$”>
<! [ CDATA [select distinct component, notation_e

from v_tac_36 where tnr = ′$MachineSpec$′] ]>

</DefineVar>
<DefineVar Name=“$NumOfColumnsInReports$”>

<! [ CDATA [7] ]>

</DefineVar>
<DefineVar Name=“$PageLayoutUnits$”>

<! [ CDATA [cm] ]>

</DefineVar>
<DefineVar Name=“$PageLayouts$”>

<! [ CDATA [2] ]>

</DefineVar>

<DefineVar Name=“$LeftMargins$”>

<! [ CDATA [2] ]>

</DefineVar>

<DefineVar Name=“$RightMargins$”>

<! [ CDATA [1.25] ]>

</DefineVar>

<GroupParts Loop+“RecordCount”

Query+“Q_ComponentLost” CreateFile=“Multiple”>

<DocHeader ID=“N$CornponentList$” File+“3.6.2-

$ComponetList$.sgm”>

<MachineType>$Heading1$</MachingeType>
<DocType>$Heading3$</DocType>
<DocSuperType>$Heading2$</DocSuperType>
<DocDesc>$Headings4$</DocDesc>
<MachineSubtype></MachingeSubType>
<MoreDocDesc>$Heading5$</MoreDocDesc>

</DocHeader>

<PartsList>

<Table>

<Title></Title>

<TGROUP COLS=$NumOfColumnsInReports$”>

<COLSPEC COLNAME=“$ColIndex$”

COLWIDTH=“SUI_Col_Width$”
Expand=“$NumOfColumnsInReport$”>
<THREAD VALIGN=“TOP”>

<ROW>

<ENTRY COLNAME=“$ColIndex$”

MOREROWS=“0” ROTATE=“0” ROWSEP=“0”
Expand=“$NumOfColumnsInReport$”>

</ENTRY>

</ROW>

</THREAD>

<TBODY>

<ROW Loop=“RecordCount” Query=“Q_PartsList”>

<ENTRY COLNAME=“$ColIndex$”

MOREROWS=“0” ROTATE=“0” ROWSEP=“0”
Expand=“$NumOfColumnsInReport$”>
</ENTRY>

</ROW>
</TBODY>

</TGROUP>

<Table>

<PartsList>
<DocFooter>

<CompanyLabel>$CompanyLabels$</CompanyLabel>

<Docnum>3.6.2-$ComponentList$</Docnum>

<DivisionLabel>$DivisionLabel$</DivisionLabel>

<DocDate>$Date$</DocDate>

</DocFooter>

<GroupParts>

<DocSpec>

What is claimed is:

1. A document generation system for producing a structured document from information derived from an information repository, comprising:
a source of document generation control information determining a desired presentation format and content structure of a generated document;
a document template generator for applying said control information in generating a template document structure comprising item locations designated for ordered data items; and
a document processor for applying said control information in filling template document item locations with corresponding ordered data elements derived from said information repository, to produce a generated document.

2. The system according to claim 1, wherein said document processor further applies said control information in transforming said generated document to be compatible with said desired presentation format to produce an output document.

3. The system according to claim 2, wherein said document processor further transforms said output document for incorporation in an electronic browseable directory.

4. The system according to claim 1, wherein said document processor applies said control information in filling template document item locations by, identifying information elements in said information repository associated with individual item locations using attributes in said control information associated with individual locations and by retrieving information elements identified by said attributes from said information repository for insertion in corresponding item locations.

5. The system according to claim 1, wherein said document processor examines said template document item locations and marks them for content filling with a content identification marker, and retrieves information elements identified by said marker from said information repository for insertion in corresponding item locations.

6. The system according to claim 5, wherein said document processor also marks an item location in said template document with a content style attribute, and retrieves a corresponding content style attribute identified by said marker from said information repository and uses said attribute in processing an information element for insertion in said item location.

7. The system according to claim 1, wherein said template document comprises a row and column tabular structure of item locations and said document processor searches said information repository for corresponding data elements in one or more of, (a) row order and (b) column order.

8. The system according to claim 1, wherein said generated document comprises one or more of, (a) an SGML document, (b) an XML document, (c) an HTML document (d) a document encoded in a language incorporating distinct content attributes and presentation attributes, and (e) a multimedia file.

9. The system according to claim 1, wherein said source of document generation control information comprises an SGML document comprising an expandable document structure.

10. The system according to claim 1, wherein said document template generator applies said control information to generate said template document structure by, expanding item location nodes in a data structure derived from said control information, said item location nodes being designated to hold ordered data items.

11. The system according to claim 1, wherein said document template generator expands said data structure derived from said control information in response to an instruction in said control information.

12. The system according to claim 1, wherein said control information comprises an expandable document structure identified by a language type definition descriptor and said document template generator generates a template document structure by expanding said expandable document structure in a manner compatible with said document structure language identified by said descriptor.

13. A document generation system for producing a structured document from information derived from a database, comprising:
a source of document generation control information comprising an expandable document structure, said control information determining a desired presentation format and content structure of a generated document;
a document template generator for expanding said expandable document structure to provide a template document structure comprising item locations designated for hierarchically ordered data items; and
a document processor for applying said control information in filling template document item locations with corresponding hierarchically ordered data elements derived from said database, to produce a generated document.

14. The system according to claim 13, wherein said document processor examines said template document item locations and marks them for content filling with a content identification marker, and retrieves information elements identified by said marker from said information repository for insertion in corresponding item locations.

15. The system according to claim 14, wherein said document processor also marks an item location in said template document with a content style attribute, and retrieves a corresponding content style attribute identified by said marker from said information repository and uses said attribute in processing an information element for insertion in said item location.

16. A graphical User interface system supporting processing of a document specification file to provide information supporting generating a structured document, comprising:
a menu generator for generating:
at least one menu permitting User selection of said document specification file and a document format; and
an icon for generating said structured document from said document specification corresponding to a database, wherein said structured document comprises content placeholders and attribute placeholders.

17. The graphical User interface of claim 16, further comprising a second menu for generating said structured document.

18. The graphical User interface of claim 17, wherein said second menu for generating said structured document further comprises:
a document structured template transformer;
a document content filler; and
a document maker.

19. A method for generating a structured document from information derived from a database, comprising the steps of:
receiving generation control information comprising an expandable document structure, said control information determining a desired presentation format and content structure of a generated document;
expanding said expandable document structure to provide a template document structure comprising item locations designated for ordered data items; and
applying said control information in filling template document item locations with corresponding ordered data elements derived from said database, to produce a generated document by, retrieving information elements from said database determined by content identification attributes in said control information for insertion in filling template document item locations.

20. The method according to claim 19, further including the step of applying a content style attribute in said control information in processing an information element for insertion in said template document item locations.

21. The method according to claim 20, wherein said content style attribute comprises at least one of, (a) number of characters per line, (b) number of lines per page, (c) font type and size, and (d) text style.
